(19) United States
(12) Patent Application Publication
(10) Pub. No.: US 2009/0132159 A1
(43) Pub. Date: May 21, 2009

(54) NAVIGATION APPARATUS

(75) Inventors: LUNG DAI, Tu-Cheng (TW); ZHI-PENG MA, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/185,121

(22) Filed: Aug. 4, 2008

(30) Foreign Application Priority Data
Nov. 16, 2007 (CN) 200710202567.7

(51) Int. Cl. G01C 21/00

(52) U.S. Cl. 701/200

(57) ABSTRACT

A navigation apparatus is provided for performing navigation functions with self-generated power from light from the sun. The navigation apparatus includes a main body and a solar panel. The main body is mainly for performing the navigation functions. The solar panel is pivotally connected to the main body. The solar panel is configured for receiving light, transforming light energy of the light into electric power, and supplying the electric power to the main body.

### BACKGROUND

1. Field of the Invention

The present invention generally relates to a navigation apparatus used in a vehicle device.

2. Description of Related Art

Navigation apparatuses, for example, global positioning system (GPS) navigation apparatus and general packet radio service (GPRS) navigation apparatus, are widely used in vehicles. The navigation apparatuses are always provided with independent batteries or converters that receive power from power sources of the vehicle devices. However, capacities of both the batteries and the power sources of the vehicle devices are limited and definite. The navigation apparatuses may stop navigating at any moment when the batteries or the power sources run out of power.

Therefore, an improved navigation apparatus is needed in the industry to address the aforementioned deficiency.

### SUMMARY

A navigation apparatus includes a main body and a solar panel. The main body is mainly for performing the navigation functions. The solar panel is pivotally connected to the main body. The solar panel is configured for receiving light from the sun, transforming light energy of the light into electric power, and supplying the electric power to the main body.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram showing a navigation apparatus in accordance with an exemplary embodiment.

FIG. 2 is a schematic diagram showing the navigation apparatus of FIG. 1 viewed from another side.

FIG. 3 is schematic diagram showing a partial vehicle device using the navigation apparatus of FIG. 1.

FIG. 4 is a block diagram showing detailed structure of a navigation apparatus in accordance with an exemplary embodiment.

### DETAILED DESCRIPTION

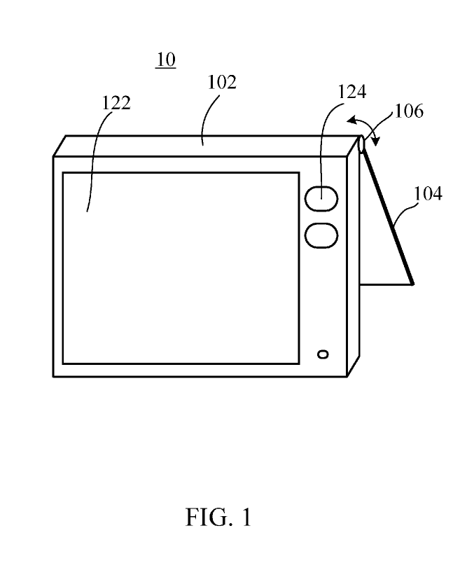

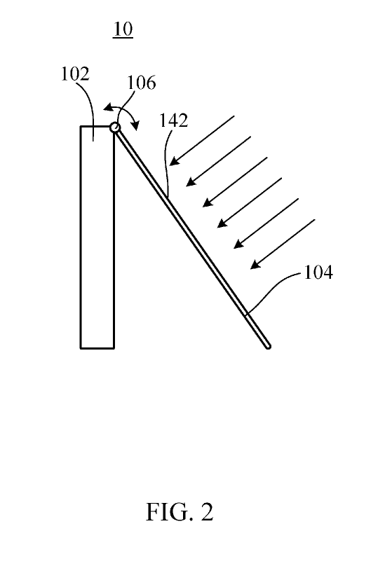

Referring to FIGS. 1 and 2, a navigation apparatus 10 in accordance with an exemplary embodiment is illustrated. The navigation apparatus 10 includes a main body 102, a solar panel 104, and a hinge 106. The solar panel 104 is pivotally connected to the main body 102 via the hinge 106.

The main body 102 has a substantially cubic shape, and is for performing navigation functions. The main body 102 includes a display screen 122 and two buttons 124. The display screen 122 is configured for displaying navigational information. The two buttons 124 are provided for users to control navigation procedures and select proper functions. There are many kinds of detailed inner structures of the main body 102 in the field.

The solar panel 104 is configured for receiving light from the sun and transforming light energy into electric power, and further supplying the electric power to the main body 102. The solar panel 104 is a rectangular sheet. A connection side of the solar panel 104 is pivotally connected to the main body 102 via the hinge 106. A length of the solar panel 104 is longer than a height of the main body along a direction perpendicular to the connection side of the solar panel 104.

In the embodiment, an outer surface 142 of the solar panel 104 is a light-receiving surface including a plurality of solar cells (not shown) for receiving the light and transforming light energy of the light into the electric power. In other embodiments, another surface opposite to the outer surface 142 can also be configured as a light-receiving surface.

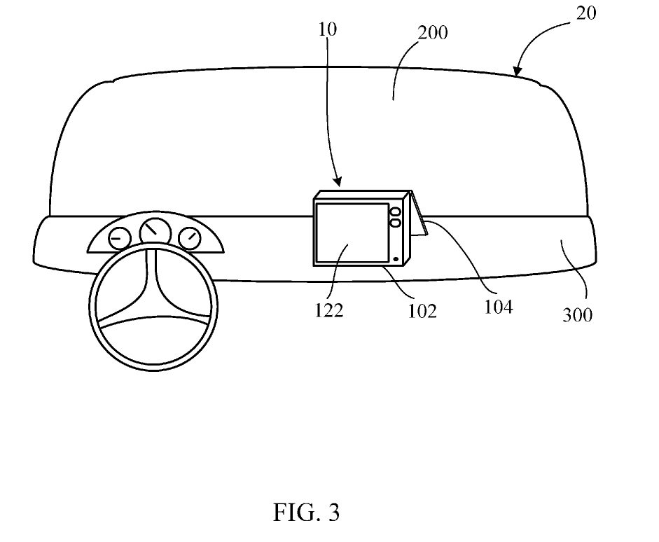

Also referring to FIG. 3, the navigation apparatus 10 is used in a vehicle device 20 partially shown. The vehicle device 20 includes a front windshield 200 and a dashboard 300 assembled next to the front windshield 200. The navigation apparatus 10 is disposed on the dashboard 300. The display screen 122 faces the interior (not shown) of the vehicle device 20. The solar panel 104 is substantial parallel to the front windshield 200 and thus the outer surface 142 faces the front windshield 200 and receives light passing through the front windshield 200. In practice, the incidence angle of the light always varies, thus the solar panel 104 can be pivotally adjusted to a proper position to adequately receive the light.

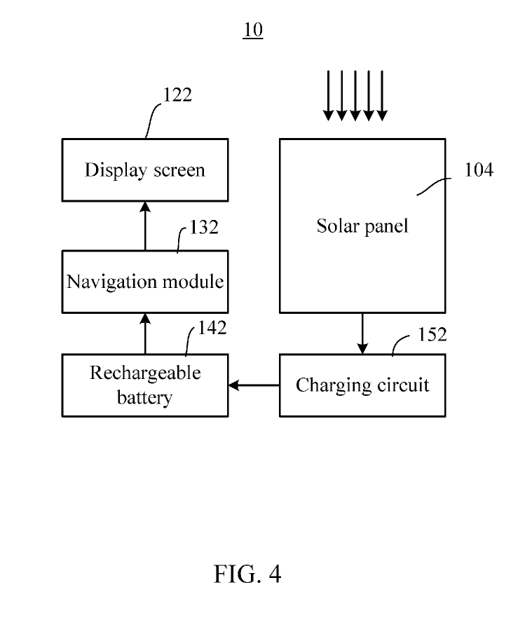

Further referring to FIG. 4, a block diagram of the navigation apparatus 10 is illustrated. The navigation apparatus 10 includes the display screen 122, a navigation module 132, a rechargeable battery 142, a charging circuit 152, and the solar panel 104. All the components except for the solar panel 140 are received in the main body 102. The navigation module 132 receives global positioning system (GPS) signals or general packet radio service (GPRS) signals, and generates navigation information. The display screen 122 displays the navigation information. The solar panel 104 receives the light and transforms light energy of the light into the electric power. The charging circuit 152 charges the rechargeable battery 142 with the electric power. The navigation apparatus 10 generates the electric power itself by receiving the light without using any external power source, thus the navigation apparatus 10 will not occupy limited power source of the vehicle device 20 and also will not be restricted by batteries.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A navigation apparatus comprising:
a main body for performing navigation functions; and
a solar panel pivotally connected to the main body, and configured for receiving light from the sun, transforming light energy of the light into electric power, and powering on the main body with the electric power.

2. The navigation apparatus according to claim 1, further comprising a hinge pivotally connecting the solar panel to the main body.

3. The navigation apparatus according to claim 2, wherein a connection side of the solar panel pivots on the hinge.

4. The navigation apparatus according to claim 3, wherein a length of the solar panel is longer than a height of the main body along a direction perpendicular to the adjacent side.

5. The navigation apparatus according to claim 1, wherein an outer surface of the solar panel is configured for receiving the light.

6. The navigation apparatus according to claim 5, wherein another surface opposite to the outer surface of the solar panel is also configured for receiving the light.

7. The navigation apparatus according to claim 1, wherein the main body comprise a display screen for displaying the navigation information.

8. The navigation apparatus according to claim 7, wherein the main body comprises a navigation module for generating the navigation information.

9. The navigation apparatus according to claim 8, wherein the main body comprises a rechargeable battery and a charging circuit for charging the rechargeable battery with the electric power.
